(19) United States
(12) Patent Application Publication
(10) Pub. No.: US 2007/0287824 A1
(43) Pub. Date: Dec. 13, 2007

(54) WATERBASED POLYURETHANE FLOOR COATING COMPOSITION

(76) Inventor: Mitchell T. Johnson, Hudson, WI (US)

Correspondence Address: 3M INNOVATIVE PROPERTIES COMPANY, PO BOX 33427, ST. PAUL, MN, 55133-3427, US

(21) Appl. No.: 11/423,061

(22) Filed: Jun. 8, 2006

(51) Int. Cl. C08G 18/00

(52) U.S. Cl. 528/85

(57) ABSTRACT

A coating composition that is particularly suited as a floor coating. The composition is an aqueous two-part or two-component polyurethane system, having a water dispersible polyisocyanate component and a hard cyclic diol component. The composition can be applied as a fairly thin coating, e.g., less than 5 mil thick, and provides a suitable coating with one coat. The composition, when coated onto a surface such as a floor, can be cured under ambient conditions. The resulting coating provides a durable coating with high gloss.

### FIELD OF THE DISCLOSURE

The present invention relates to a waterbased two-part polyurethane finish composition useful for providing a coating or film to a substrate surface such as a floor.

### BACKGROUND OF THE DISCLOSURE

Polymer compositions are used in various coating compositions such as floor finishes or polishes, for example. Commercially available floor finish compositions typically are aqueous emulsion-based polymer compositions comprising one or more organic solvents, plasticizers, coating aides, anti-foaming agents, polymer emulsions, metal complexing agents, waxes, and the like. The polymer composition is applied to a floor surface and then allowed to react and dry in air, normally at ambient temperature and humidity. A film is formed that serves as a protective barrier against soil deposited on the floor by pedestrian traffic, for example. These same polymer compositions can be applied to other substrate surfaces for which protection is desired, such as tile floors, walls, furniture, windows, counter tops, and bathroom surfaces, to name but a few.

Although many of the commercially available aqueous floor finishes have performed well and have experienced at least some commercial success, opportunities for improvement remain. In particular, it is highly desirable that the resultant floor finish film exhibits certain physical and performance characteristics including overall durability, hardness, scratch resistance, soil resistance, black marks/scuff resistance, abrasion resistance, and high gloss. Further, it is highly desirable to have a floor finish material that is easy to apply.

### SUMMARY OF THE DISCLOSURE

The present invention provides a reactive coating composition that, upon curing, is particularly suited as a floor coating. The composition is an aqueous two-part or two-component polyurethane reactive system, having a water dispersible polyisocyanate component and a cyclic diol hard segment component. After the two components are mixed, the reactive composition can be applied as a fairly thin coating, e.g., less than 5 mil thick. The reactive composition, when coated onto a surface such as a floor, can be cured and dried under ambient conditions. After curing and drying, the resulting reacted coating provides a durable finish with a high gloss, often with one coat.

In one particular aspect, this disclosure provides a reactive composition comprising a first component or first reactive comprising a water dispersible isocyanate, and a second component or second reactive comprising a cyclic aliphatic alcohol, such as cyclohexanedimethanol. In some embodiments, the cyclohexanedimethanol is 1,4-cyclohexanedimethanol. In some embodiments, the first component consists of water dispersible isocyanate and water, and the second component consists of cyclohexanedimethanol and water. Optional additives may be present in the first component, in the second component, or added to the reactive composition after the first component has been mixed with the second component.

In another particular aspect, this disclosure provides a method for making a reactive composition, the method including providing a first component comprising a water dispersible isocyanate in a first vessel, and providing a second component comprising cyclohexanedimethanol in a second vessel, and then combining the first component with the second component to provide the reactive composition. Other ingredients may be present in the first component, in the second component, and/or in the reactive composition.

Yet another particular aspect of this disclosure is to a method of applying a reactive composition to a surface. The method includes combining a first component comprising a water dispersible isocyanate with a second component comprising a cyclohexanedimethanol to provide a reactive composition, and then applying the reactive composition to a surface. In many embodiments, the surface is a floor, such as a tile floor or a linoleum floor. The reactive composition may be applied at a thickness of no more than about 5 mil, or no more than about 2 mil.

These and other embodiments and aspects are within the scope of this disclosure.

### BRIEF DESCRIPTION OF THE DRAWINGS

FIG. 1 is a perspective view of a user using an applicator system for applying the reactive coating composition of the present invention to a floor.

FIG. 2 is a perspective view a portion of the applicator system of FIG. 1, particularly, an applicator device;

FIG. 3 is a perspective view of a portion of the applicator device of FIG. 2, particularly, an application head; and

FIG. 4 is an end view of the application head of FIG. 3.

### DETAILED DESCRIPTION

The present disclosure provides a reactive coating composition that is a two-part or two-component system, which upon combining of the two parts, provides an aqueous reactive polyurethane composition suitable for use as floor coating. The reactive composition includes a water dispersible polyisocyanate component or reactant and a cyclic diol hard segment component or reactant. Individual components of the composition are described in greater detail below. The composition is easy to apply to a surface, such as a floor.

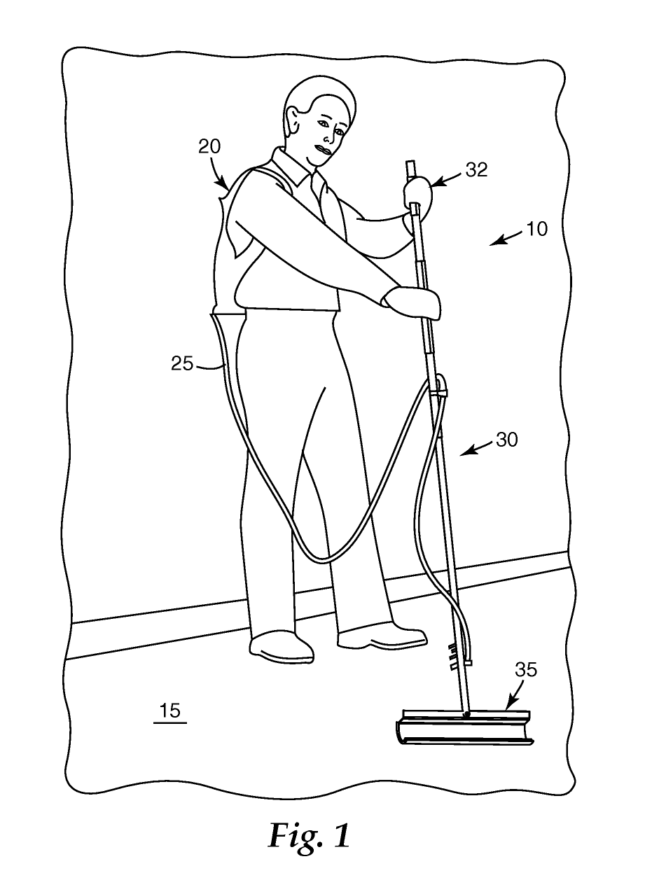

Referring to the figures, a system for applying the reactive coating composition to a surface, such as a floor, is illustrated. Illustrated in FIG. 1 is a user with an exemplary coating applicator system 10 applying a liquid coating composition onto floor 15. Applicator system 10 includes a liquid retainer 20 for storing the liquid coating composition prior to application to floor 15 and an applicator device 30 that applies the liquid coating to floor 15. Liquid retainer 20 may have two separate compartments (not seen) for separating the two components of the coating composition until ready to be combined (e.g., reacted) and then dispensed and applied. A hose or other connecting passage 25 provides liquid coating composition from retainer 20 to applicator device 30.

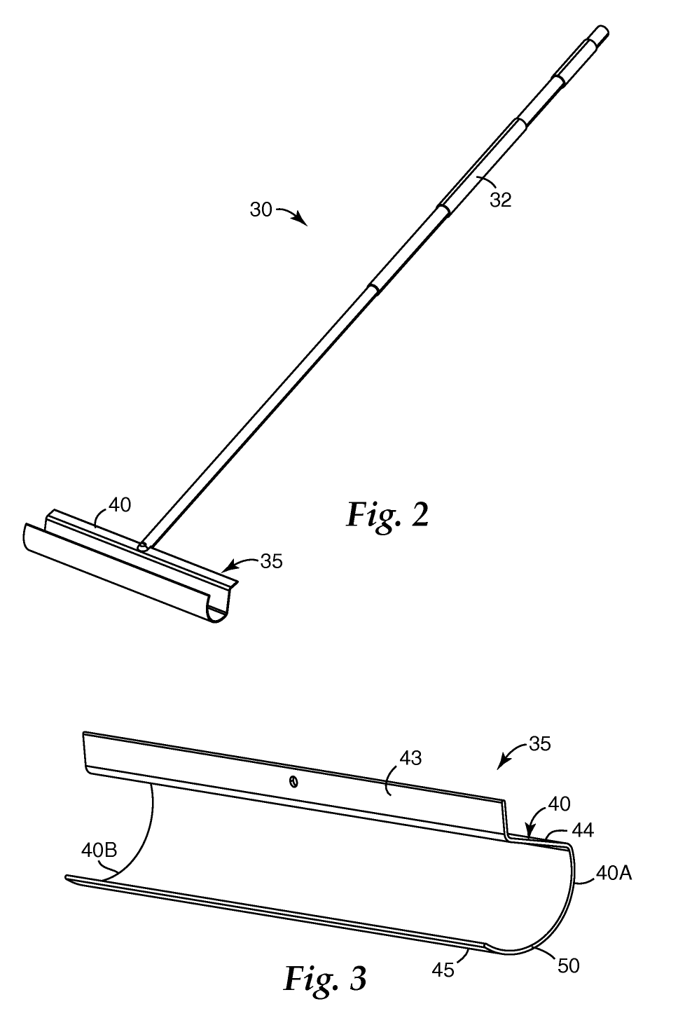

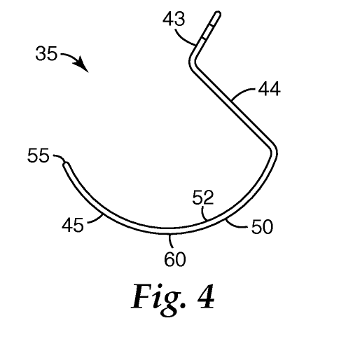

Applicator device 30, also seen in FIG. 2, has a handle 32 connected to an application head 35, which is shown in more detail in FIGS. 3 and 4. Application head 35 has a body 40 with a first end 40A and an opposite second end 40B. Body 40 includes a first portion 43 for connecting to handle 32 and a second portion 45 which is configured for application of the liquid composition onto floor 15. Present between first portion 43 and second portion 45 is a transition portion 44.

Second portion 45, with in outer surface 50 and an inner surface 52 has an arcuate shape terminating at tip 55. Second portion 45 includes a contact area 60 on outer surface 50. Contact area 60 extends from first end 40A to second end 40B in the longitudinal direction of second portion 45, which is the direction between tip 55 and where second portion 45 meets with transition portion 44.

The various portions of body 40, e.g., first portion 43, second portion 45 and transition portion 44, can be formed from a sheet of material, such as thermoplastic. In most embodiments, body 40 is at least partially flexible or deformable, particularly at second portion 45, when a force is applied to body 40 at first portion 43. In some designs of application head 35, body 40 is sufficiently flexible so that the depth of contact area 60, i.e., in the longitudinal direction, is about 1 inch.

In some embodiments, application head 35 is used in conjunction with an applicator pad, which are generally well known for applicator systems. Examples of suitable pads include microfiber pads, fleece, and foam.

Additional details regarding applicator system 10 and variations thereof are disclosed in co-pending patent application having attorney docket no. 62025US002, filed on even date herewith, the entire disclosure of which is incorporated by reference.

It should be understood that applicator system 10 and the various features thereof that have been described herein and in co-pending patent application having attorney docket no. 62025US002 are only examples of suitable systems for applying the liquid coating composition of the present disclosure onto a surface. Other applicator systems can also be used. For example, additional embodiments of applicator heads, other than just applicator head 35, are disclosed in co-pending patent application having attorney docket no. 62025US002.

In some instances the surface to be coated must be prepared, for example, by cleaning, stripping to remove previous coatings, and/or priming.

As provided above, the reactive coating composition of this disclosure includes a reactive mixture of a water dispersible polyisocyanate component and a cyclic diol hard segment component Generally, the polyisocyanate component and the cyclic diol hard segment component are kept separate until they are mixed, after which they begin to react and are thus ready for application onto a surface. The two components are mixed, preferably thoroughly mixed to be homogeneous, to form a reactive coating composition. Generally, the two components begin reacting with each other upon contact.

Prior to mixing, the polyisocyanate component and the cyclic diol hard segment component are preferably stored separately in air-tight vessels until ready to be mixed. Reducing the exposure to air and moisture during storage is believed to retain reactivity of the individual components as well as reduce the potential for air entrainment and bubble formation-in each individual component and when the components are mixed. The coating applicator system may include a mixing nozzle or other element to combine the two components as they are dispensed from their individual vessels. For example, referring to coating applicator system 10, retainer 20 can have two compartments, one for the polyisocyanate component and one for the cyclic diol hard segment component. Connecting passage 25, which extends from retainer 20, can have mixing elements at the entrance or throughout at least a portion of its length to thoroughly mix the two components as they flow towards applicator device 30. In such a system, however, care should be taken so that the two individual components are mixed at proper ratios.

A preferred coating applicator system includes a multi-compartment plastic bag or pouch, one for each of the components, which have internal seals that are readily and controllably rupturable. To mix the components, the internal divider between the two pouches is ruptured and the individual components are mixed, for example, by kneading. The mixed components are dispensed from the pouch as a reactive composition.

One preferred storage system for the two components, which also functions as a dispensing unit, is described in PCT publication WO 2004/108404, the entire disclosure of which is incorporated by reference. This publication discloses various embodiments of multi-compartment plastic bags or pouches.

In some embodiments, depending on the specific polyisocyanate component and the specific cyclic diol hard segment component used, the mixed composition may undergo a color change due to the reaction between the two components. For example, each component individually may be clear and generally colorless, whereas upon mixing, the resulting composition has a cloudy or opaque appearance. Such a color change is beneficial, for example, as an indicator that the two components have been thoroughly mixed. Clear streaks would indicate regions of material that have not been thoroughly mixed.

The reactive composition, with the polyisocyanate component, the cyclic diol hard segment component, and any optional additives, usually has a solids level of at least about 20% and usually no more than about 75%. In some embodiments, the solids level is about 30-45%.

The reactive coating composition typically has a viscosity of about 80 to 190 cps, usually about 120-150 cps, is easy to apply, and readily flows to even out low spots. The reactive composition provides a thin, easily managed coating. Typically, only one pass with an applicator, such as applicator device 30, is needed to obtain a smooth an even coating. One pass is preferred, to inhibit the creation of air bubbles on the surface, which often form when multiple passes of the applicator device are made.

The reactive composition is easy to apply to a surface, such as a floor, using an application system such as system 10. A reactive composition coating thickness of usually no more than 5 mil (about 127 micrometers) is applied to the surface. In some embodiments, depending on the composition and the surface being coating, an applied coating of 2 mil (about 51 micrometers), or even an applied coating of about 1 mil (about 25 micrometers) provides a sufficient resulting coating. When cured and dried, the thickness of the resulting coating is usually no more than about 3 mil (about 76 micrometers), often no more than about 2.5 mil (about 63 micrometers).

The drying and curing time for the coating composition depends on the specific individual components used in the composition, the coating thickness, and of course, temperature of the surface, temperature and humidity of the surrounding air, and the amount of air circulation in the immediate area of the applied reactive composition.

Upon drying and curing, the resulting coating has a high gloss and is highly durable. In many embodiments, the gloss of the dried coating is at least 85 at 60°, and in some embodiments, the gloss is at least 90 at 60°.

Discussing now the individual components that form the reactive composition that results in the dried coating, the first component of the two-part composition is a polyisocyanate, more specifically, a water-dispersible polyisocyanate. It is known that isocyanates, in general, lose at least a portion of their reactivity when combined with water. The present invention, however, has achieved a water-based reactive composition with isocyanate that retains sufficient reactivity to provide a suitable, and improved, reactive coating composition and cured coating that is particularly suited for floors.

A water dispersible isocyanate is commercially available, for example, from Bayer under the designation “Bayhydur 302”. “Bayhydur 302” is a water-dispersible polyisocyanate based on hexamethylene diisocyanate (HDI), suitable for use as a hardener in waterborne reactive polyurethane systems for adhesives and coatings. According to Bayer, it has outstanding weather stability and gloss retention and is non-yellowing. The NCO content is 17.3%±0.5, the amount of solids is 99.8% minimum, and it has a viscosity of 2,300±700 mPa·s@25° C.

The water dispersible isocyanate is generally clear, having no appreciable opacity or color. This first component may include added to it optional additives and adjuvants which may alter the physical characteristics of the first component, however, the presence of optional additives is generally not preferred.

The first component in the waterborne side of the two-part composition includes a hydroxyl functionalized polymer that is a polyether, or polyester. These polymers make up the soft segment of the polyurethane. A number of different materials exist and are readily known to those skilled in the art. The polyol is usually supplied as a water dispersion in the solids range of 30 to 40%. A preferred polyol is a polyester available from Bayer under the designation “Bayhydur XP 7093”. It provides the non-yellowing, high gloss and chemical resistance needed in a floor coating.

The second component of the two-part composition is an aliphatic hard segment component, in many embodiments a cyclic aliphatic hard segment component. The hard segment is an alcohol, and in most embodiments, a primary alcohol.

A preferred cyclic alcohol for use in the reactive composition is a cyclic diol such as cyclohexanedimethanol, sometimes also referred to as cyclohexyldimethanol or as CHDM. In some embodiments, cyclohexanedimethanol is a solid at room temperature. This solid can be dissolved or dispersed in solvent, e.g., at room temperature to form a stable mixture. Most solutions of cyclohexanedimethanol have a mixture of the cis and trans forms.

A preferred cyclohexanedimethanol is 1,4-cyclohexanedimethanol, which is commercially available from, for example, Eastman under the designation “CHDM-D Glycol”, which is a symmetrical, high molecular weight cycloaliphatic glycol. “CHDM-D90”, also from Eastman, is a 90/10 weight percent solution of CHDM-D in water, and is liquid at room temperature.

The amount of active isocyanate and cyclic diol is typically similar, with molar ratios of isocyanate to cyclic diol generally being 2:1 to 1:2. In some embodiments, the two components are present in an actives weight ratio of about of 1.5:1 to 1:1.5, and in some embodiments about 1.25:1 to 1:1.25.

The reactive composition of the invention, with the isocyanate and cyclic diol components combined, typically has an actives content from about 25 to about 50 wt-%. In some embodiments, the actives are about 30 to 45 wt-%, and preferably are about 40 wt-% based on the weight of the reactive composition. It is not necessary to dilute the reactive composition after mixing, however, if done, the actives would typically be about 10-25 wt-% of the reactive composition. As used herein the term “active” or “active ingredient” means the ingredient alone or in combination has an effect on the polymerization of the composition. The active ingredients for the compositions of the present disclosure are the isocyanate and the cyclic diol. In contrast, “inactive” means the component is added primarily for aesthetic purposes, such as odor, color, and the like, or is an ingredient other than an isocyanate or a cyclic diol.

The pH of the reactive composition, with the two components mixed, is typically in the range of about 6 to about 10.5. In some embodiments, the pH is between about 7.5 and about 9.9. A pH adjuster (e.g., acids or bases) may be added to the composition to obtain the desired pH; typically, the composition is inherently acidic, so the pH is raised. The pH can be adjusted using various bases or buffering agents. Suitable bases or buffering agents include, for example, borax, sodium hydroxide, alkali phosphates, alkali silicates, alkali carbonates, ammonia, and amines such as diethanolamine or triethanolamine.

While not being bound herein, it is theorized that that upon reaction with isocyanate, the cyclic diol hard segment forms a chain extending urethane linkage. It is also though that the cyclohexane ring hard segment inverts at room temperature forming a rod-type void in the film. This allows the polymer chains, when cured, to distort and absorb impacts, which in turns resists abrasion. When more linear systems such as 1,4-butanediol (BDO) are used, the abrasion resistance is decreased; this supports the theory that the cyclic structure inverts.

A decrease in gloss of the cured coating is also observed when other diol hard segment chain extenders are used in place of cyclohexanedimethanol. This adds further evidence to the uniqueness of cyclohexanedimethanol as a hard segment chain extender.

In addition to the isocyanate and cyclic diol components, respectively, the individual components can also contain other ingredients such as polyvalent metal compounds, alkali soluble resins, waxes, permanent and fugitive plasticizers, defoamers, wetting agents, and biocides. Additionally or alternately, any optional ingredients may be added after the reactive composition has been formed by the mixing of the two individual components. The polyvalent metal compound provides crosslinking of the polymers in the film and increases the detergent resistance of the finish. Plasticizers or coalescing agents can be added to lower the temperature of film formation. Alkali soluble resins improve the ability of the finish to be stripped from the substrate before reapplication of a fresh coating. Waxes improve the gloss of the finish and allow the finish to be buffed. Biocides help minimize the formation of molds or mildew in the coating. Antifoamers and defoamers minimize the formation of bubbles in the coating.

After mixing of the two components, the resulting reactive composition can be applied to a variety of surfaces such as, for example, floors, walls, counter tops and shelving, furniture, and bathroom surfaces. Preferably, the substrate is a floor, but can be any surface upon which the coatable composition of the present invention can be applied. The surface can be generally any material, such as vinyl, linoleum, tile, ceramic, wood, marble, and the like.

After curing and drying (i.e., after complete reaction), the resultant coatings are smooth, exhibit increased hardness and modulus, and are highly resistant to scratches and soil. The resulting coatings are very durable.

The following examples and comparative examples further describe the finish compositions of the invention, methods of using the finish compositions, and the tests performed to determine the various characteristics of the finish composition. The examples are provided for exemplary purposes to facilitate an understanding of the invention, and should not be construed to limit the invention to the examples.

Example 1 was prepared by providing a water dispersible polyisocyanate component (i.e., Component A in Table 1, below) and a cyclohexane diol hard segment component, (i.e., Component B in Table 2). Component B was prepared by mixing together, in the order listed, the listed ingredients at the provided amounts, except for the Dowanol surfactant which was first mixed into the water.

Both Component A and Component B, individually, were clear. Upon combination of the two Components, the resulting reactive composition was milky white.

TABLE 1
Component A

| Ingredient | mass (g) | moles | Equiv. wt |
|---|---|---|---|
| “Bayhydur 302” isocyanate | 44.00 | 0.1811 | 243.00 |

“Bayhydur 302” is 1,4-cyclohexanedimethanol available from Bayer.

TABLE 2
Component B

| Ingredient | mass (g) | moles | Equiv. wt |
|---|---|---|---|
| Trimethylol propane (75%) | 0.33 | 0.0054 | 61.59 |
| “Bayhydrol XP 7093” polyester resin | 42.69 | 0.0374 | 1140.00 |
| 1,4-cyclohexanedimethanol | 7.15 | 0.0754 | 94.81 |
| Water | 2 | 0.1111 | 18 |
| Triethylamine | 0.31 | 0.0031 | 101.19 |
| Water | 100 | 5.5556 | 18 |
| “Dowanol PnB” | 3 | 0.0227 | 132.2 |
| “Byk 346” surfactant | 0.33 | | |
| “Byk 381” surfactant | 0.33 | | |

“Bayhydrol XP 7093” a polyester resin dispersed in water/ammonia available from Bayer.
“Byk 346” is a silicone surfactant available from BYK Chemi GmbH.
“Byk 381” is a surfactant available from BYK Chemi GmbH.

Nine comparative reactive compositions were made, using the formula described in Example 1, but with the cyclic diol identified in Table 3 in place of the cyclohexanedimethanol.

Example 1, the nine made comparative examples, and a commercially available product “GlossTek” from Ecolab, were applied to a linoleum tile and allowed to react and dry to provide a 2 mil (about 51 micrometer) thick coating.

Twenty-four hours after coating, the gloss of the coating was measured using and a with a BYK Gardner Gloss Meter using ASTM D 1455 and at 60°. The results were recorded and are reported in Table 3.

The coated linoleum tiles were abrading using the following Abrasion Test Method, after which the gloss of the coating was again measured and the results were recorded and are reported in Table 3.

The abrasion test was conducted following ASTM D3206-87. The soil used was modified by adding 20 wt % of playground sand found at local hardware stores. The sand was dried in a 120° C. forced air oven. The tiles were wiped with a soft damp cloth and then read using a Gloss Meter as described above at 60°.

TABLE 3
Comparatives and Gloss Test Results

| Example | Diol | Initial Gloss | Abraded Gloss |
|---|---|---|---|
| 1 | CHDM | 94 | 90 |
| Comparative 1 | BDO | 80 | NA |
| Comparative 2 | HDO | 85 | 80 |
| Comparative 3 | MPDIOL | 89 | 86 |
| Comparative 4 | HQEE | 40 | NA |
| Comparative 5 | MBOCA | 0 | NA |
| Comparative 6 | EDA | 0 | NA |
| | | (gelled) | |
| Comparative 7 | EG | 0 | NA |
| Comparative 8 | DEG | 0 | NA |
| Comparative 9 | None | 87 | 60 |
| Comparative 10 | “GlossTek” | 86 | 78 |
| | from Ecolab | | |

“CHDM” was cyclohexanedimethanol.
“BDO” was butane diol.
“HDO” was hexane diol.
“MPDIOL” was 2,2-dimethyl 1,3 propanediol.
“HQEE” was hydroxymethylquinol ether (aromatic).
“MBOCA” was methylene bis-metachlorodianaline.
“EDA” was ethylene diamine.
“EG” was ethyleneglycol.
“DEG” was diethylene glycol.

For the abraded results recorded as “NA”, the films were too tacky to obtain gloss readings.

The examples and results above show that coating composition made with cyclohexanedimethanol (i.e., Example 1), an aliphatic primary alcohol, performed better than coatings made with non-cyclic components (i.e., hexane diol and 2,2-dimethyl 1,3 propanediol) and also better than the tested commercially available product. The coating composition made with cyclohexanedimethanol (i.e., Example 1) performed significant better than coatings made with butane diol, hydroxymethylquinol ether, methylene bis-metachlorodianaline, ethylene diamine, ethyleneglycol, or diethylene glycol.

The invention has been described with reference to various embodiments and techniques. However, it will be apparent to one of ordinarily skill in the art that many variations and modifications may be made while remaining within the spirit and scope of the invention.

What is claimed:

1. A reactive composition comprising:
a first component comprising a water dispersible isocyanate; and
a second component comprising cyclohexanedimethanol.

2. The composition of claim 1, wherein the cyclohexanedimethanol comprises 1,4-cyclohexanedimethanol.

3. The composition of claim 1 wherein the first component consists of the water dispersible isocyanate.

4. The composition of claim 1 comprising an actives ratio of the water dispersible isocyanate to the cyclohexanedimethanol of about 2:1 to about 1:2.

5. A method of making a reactive composition comprising:
providing a first component comprising a water dispersible isocyanate in a first vessel;
providing a second component comprising cyclohexanedimethanol in a second vessel; and
combining the first component with the second component to provide the reactive composition.

6. The method of claim 5, wherein providing a second component comprising cyclohexanedimethanol comprises:
(a) providing a second component comprising 1,4-cyclohexanedimethanol.

7. A method of making a reactive composition comprising:
providing a water dispersible isocyanate in a first vessel;
providing a cyclohexanedimethanol in a second vessel; and
combining the isocyanate with the cyclohexanedimethanol to provide the reactive composition.

8. The method of claim 7, wherein providing a cyclohexanedimethanol comprises:
(a) providing 1,4-cyclohexanedimethanol.

9. A method of applying a reactive composition comprising:
combining a first component comprising a water dispersible isocyanate with a second component comprising a cyclohexanedimethanol to provide the reactive composition; and
applying the composition to a surface.

10. A method of applying a reactive composition comprising:
combining a water dispersible isocyanate with a cyclohexanedimethanol to provide the reactive composition; and
applying the reactive composition to a surface.

11. The method of claim 10, wherein the surface is a floor.

12. The method of claim 11, wherein applying the reactive composition to a floor comprises:
(a) applying the reactive composition at a thickness of no more than about 5 mil.

13. The method of claim 11, wherein applying the reactive composition comprises:
(a) applying the reactive composition at a thickness of no more than about 2 mil.
